(19) United States
(12) Patent Application Publication
(10) Pub. No.: US 2026/0010602 A1
(43) Pub. Date: Jan. 8, 2026

(54) SERVICE PROCESSING

(71) Applicant: Tencent Technology (Shenzhen) Company Limited, Shenzhen (CN)

(72) Inventors: Shaoming WANG, Shenzhen (CN); Jinkun HOU, Shenzhen (CN); Runzeng GUO, Shenzhen (CN)

(73) Assignee: Tencent Technology (Shenzhen) Company Limited, Shenzhen, GD (CN)

(21) Appl. No.: 19/325,427

(22) Filed: Sep. 10, 2025

Related U.S. Application Data
(63) Continuation of application No. PCT/CN2024/099505, filed on Jun. 17, 2024.

(30) Foreign Application Priority Data
Aug. 21, 2023 (CN) 202311055923.2

(51) Int. Cl. G06F 21/32; G06V 40/12; G06V 40/16; G06V 40/18; G06V 40/40

(52) U.S. Cl. CPC G06F 21/32; G06V 40/1347; G06V 40/168; G06V 40/193; G06V 40/40

(57) ABSTRACT

Object description information that is transmitted by a biometric recognition apparatus is received, the object description information includes a biometric feature of a target object and location information of the target object. Identity information of the target object is obtained according to the biometric feature. A service information set in association with the identity information is obtained. From the service information set, one or more pieces of candidate service information are selected. The one or more pieces of candidate service information are transmitted to a terminal device associated with the identity information. At least a first piece of target service information returned by the terminal device is received. At least a first service corresponding to the first piece of target service information is processed. Apparatus and non-transitory computer-readable storage medium counterpart embodiments are also contemplated.

### RELATED APPLICATIONS

The present application is a continuation of International Application No. PCT/CN2024/099505, filed on Jun. 17, 2024, which claims priority to Chinese Patent Application No. 202311055923.2, filed on Aug. 21, 2023. The entire disclosures of the prior applications are hereby incorporated by reference.

### FIELD OF THE TECHNOLOGY

This disclosure relates to the field of computer and communication technologies, including a service processing method and apparatus, a device, a storage medium, and a program product.

### BACKGROUND OF THE DISCLOSURE

Compared with a related password recognition technology, a biometric recognition technology performs personal identification by analyzing and recognizing a physiological feature of a human body, can provide an identity authentication result more conveniently, quickly, safely, and reliably, and thus is gradually widely applied to various application scenarios. For example, in an access control scenario, a target object implements an access control unlocking function through a biometric recognition operation. For another example, in a payment scenario, the target object implements a payment function or the like through a biometric recognition operation.

However, in an actual application, if expecting to implement a specific service function through a biometric recognition operation, the target object needs to pre-configure an associated function for a service server with reference to a specific application scenario, so that after the target object passes biometric recognition, the service server can return service information related to the application scenario. This limits application and promotion of biometric recognition operations to some extent. To be specific, in one application scenario, the service server usually can feed back only one fixed type of service information, to implement one pre-configured fixed service function.

For example, in the access control scenario, a biometric recognition apparatus can receive only a door opening/closing instruction delivered by the service server, to implement the access control unlocking function.

For another example, in the payment scenario, the biometric recognition apparatus can receive only payment information fed back by the service server, to implement the payment function.

It can be learned that in the related art, if expecting to implement another service function in a specific application scenario, the target object needs to reconfigure the service server, which leads to complex service operation and maintenance operations and reduces efficiency of service processing.

### SUMMARY

Embodiments of this disclosure provide a service processing method and apparatus, a device, and a storage medium, to improve efficiency of implementing service processing based on a biometric recognition operation.

Some aspects of the disclosure provide a first method of service processing. In some examples, object description information that is transmitted by a biometric recognition apparatus is received, the object description information includes a biometric feature of a target object and location information of the target object. Identity information of the target object is obtained according to the biometric feature. A service information set in association with the identity information is obtained. From the service information set, one or more pieces of candidate service information are selected based on location information associated with the one or more pieces of candidate service information and the location information of the target object. The one or more pieces of candidate service information are transmitted to a terminal device associated with the identity information. At least a first piece of target service information returned by the terminal device is received, the first piece of target service information is selected from the one or more pieces of candidate service information. At least a first service corresponding to the first piece of target service information is processed.

Some aspects of the disclosure provide an apparatus that includes processing circuitry configured to perform the first method of service processing.

Some aspects of the disclosure also provide a non-transitory computer-readable storage medium storing instructions which when executed by at least one processor cause the at least one processor to perform the first method of service processing.

Some aspects of the disclosure provide a second method of service processing. One or more pieces of candidate service information that are transmitted by a service server are received, the one or more pieces of candidate service information are determined by the service server based on a biometric feature of a target object and location information of the target object. At least a piece of target service information is determined from the one or more pieces of candidate service information in response to a selection operation triggered by the target object. At least the piece of target service information is transmitted to the service server to cause the service server to process at least a service corresponding to the piece of target service information.

Some aspects of the disclosure provide an apparatus that includes processing circuitry configured to perform the second method of service processing.

Some aspects of the disclosure also provide a non-transitory computer-readable storage medium storing instructions which when executed by at least one processor cause the at least one processor to perform the second method of service processing.

Some aspects of the disclosure provide a third method of service processing. In some examples, object description information of a target object is obtained, the object description information includes a biometric feature of the target object and location information of the target object. The object description information is transmitted to a service server to cause the service server to perform the first method service processing. For example, in the service server, one or more pieces of candidate service information are obtained based on the biometric feature and the location information, the one or more pieces of candidate service information are transmitted to a terminal device, and a service processing is performed based on at least a piece of target service information that is selected from the one or more pieces of candidate service information by the terminal device.

Some aspects of the disclosure provide an apparatus that includes processing circuitry configured to perform the third method of service processing.

Some aspects of the disclosure also provide a non-transitory computer-readable storage medium storing instructions which when executed by at least one processor cause the at least one processor to perform third method of service processing.

According to an aspect, an embodiment of this disclosure provides a service processing method. The method includes: receiving object description information transmitted by a biometric recognition apparatus, the object description information including a biometric feature and location information of a target object; obtaining identity information of the target object that is recorded in the biometric feature, and obtaining a service information set configured in association with the identity information; selecting, from the service information set, at least one piece of candidate service information matching the location information; transmitting the at least one piece of candidate service information to a terminal device associated with the identity information, the terminal device determining at least one piece of target service information from the at least one piece of candidate service information in response to a selection operation triggered by the target object; and receiving the at least one piece of target service information returned by the terminal device, and processing a service corresponding to each piece of target service information in the at least one piece of target service information.

According to another aspect, an embodiment of this disclosure provides a service processing method. The method includes: receiving at least one piece of candidate service information transmitted by a service server, the at least one piece of candidate service information being determined by the service server based on a biometric feature and location information of a target object; determining at least one piece of target service information from the at least one piece of candidate service information in response to a selection operation triggered by the target object; and transmitting the at least one piece of target service information to the service server, so that the service server processes a service corresponding to each piece of target service information in the at least one piece of target service information.

According to another aspect, an embodiment of this disclosure provides a service processing method. The method includes: obtaining object description information of a target object, the object description information including a biometric feature and location information of the target object; and transmitting the object description information to a service server, so that the service server performs the following operations: obtaining at least one piece of candidate service information based on the biometric feature and the location information, transmitting the at least one piece of candidate service information to a terminal device, and performing service processing based on at least one piece of target service information returned by the terminal device, each piece of target service information being determined by the terminal device from the at least one piece of candidate service information in response to a selection operation triggered by the target object.

According to another aspect, an embodiment of this disclosure provides a service processing apparatus, including: a receiving module, configured to receive object description information transmitted by a biometric recognition apparatus, the object description information including a biometric feature and location information of a target object; an obtaining module, configured to: obtain identity information of the target object that is recorded in the biometric feature, and obtain a service information set configured in association with the identity information; a matching module, configured to select, from the service information set, at least one piece of candidate service information matching the location information; and a transmission module, configured to transmit the at least one piece of candidate service information to a terminal device associated with the identity information, the terminal device determining at least one piece of target service information from the at least one piece of candidate service information in response to a selection operation triggered by the target object; and the receiving module being further configured to: receive the at least one piece of target service information returned by the terminal device, and process a service corresponding to each piece of target service information in the at least one piece of target service information.

According to another aspect, an embodiment of this disclosure provides a service processing apparatus, including: a receiving module, configured to receive at least one piece of candidate service information transmitted by a service server, the at least one piece of candidate service information being determined by the service server based on a biometric feature and location information of a target object; a determining module, configured to determine at least one piece of target service information from the at least one piece of candidate service information in response to a selection operation triggered by the target object; and a transmission module, configured to transmit the at least one piece of target service information to the service server, so that the service server processes a service corresponding to each piece of target service information in the at least one piece of target service information.

According to another aspect, an embodiment of this disclosure provides a service processing apparatus, including: an obtaining module, configured to obtain object description information of a target object, the object description information including a biometric feature and location information of the target object; and a transmission module, configured to transmit the object description information to a service server, so that the service server performs the following operations: obtaining at least one piece of candidate service information based on the biometric feature and the location information, transmitting the at least one piece of candidate service information to a terminal device, and performing service processing based on at least one piece of target service information returned by the terminal device, each piece of target service information being determined by the terminal device from the at least one piece of candidate service information in response to a selection operation triggered by the target object.

According to another aspect, an embodiment of this disclosure provides a computer device, including a memory, a processor (an example of processing circuitry), and a computer program stored on the memory and capable of running on the processor. The processor implements the operations of the foregoing service processing method when executing the program.

According to another aspect, an embodiment of this disclosure provides a computer-readable storage medium, storing a computer program executable by a computer device. The program, when run on the computer device, causes the computer device to perform the operations of the foregoing service processing method.

According to another aspect, an embodiment of this disclosure provides a computer program product, including a computer program stored on a computer-readable storage medium (e.g., non-transitory computer-readable storage medium). The computer program includes program instructions. The program instructions, when executed by a computer device, cause the computer device to perform the operations of the foregoing service processing method.

### BRIEF DESCRIPTION OF THE DRAWINGS

FIG. 1 is a schematic diagram of an application scenario according to an embodiment of this disclosure.

FIG. 2 is a diagram of a system architecture of a service processing system according to an embodiment of this disclosure.

FIG. 3 is a schematic diagram of application in a transportation scenario according to an embodiment of this disclosure.

FIG. 4 is a schematic diagram of application in an in-vehicle scenario according to an embodiment of this disclosure.

FIG. 5 is a schematic flowchart of interaction in a biometric recognition-based service processing method according to an embodiment of this disclosure.

FIG. 6 is a schematic diagram of obtaining object description information according to an embodiment of this disclosure.

FIG. 7 is a schematic diagram of generating a biometric feature according to an embodiment of this disclosure.

FIG. 8 is a schematic diagram of model training for an identification model according to an embodiment of this disclosure.

FIG. 9 is a schematic diagram of matching between a biometric feature and a candidate feature according to an embodiment of this disclosure.

FIG. 10 is a schematic diagram of a service information set according to an embodiment of this disclosure.

FIG. 11 is a schematic diagram of matching between real-time location information and a scenario type according to an embodiment of this disclosure.

FIG. 12 is a schematic diagram of third-party platforms associated with four application scenarios according to an embodiment of this disclosure.

FIG. 13 is a schematic diagram of filtering reference service information according to an embodiment of this disclosure.

FIG. 14 is a schematic diagram of an object selection operation according to an embodiment of this disclosure.

FIG. 15 is a schematic diagram of a diagram of a service processing apparatus according to an embodiment of the disclosure.

FIG. 16 is a schematic diagram of a diagram of a service processing apparatus according to an embodiment of the disclosure.

FIG. 17 is a schematic diagram of a diagram of a service processing apparatus according to an embodiment of the disclosure.

FIG. 18 is a schematic diagram of a structure of a computer device according to an embodiment of this disclosure.

FIG. 19 is a schematic diagram of a structure of another computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The terms “first” and “second” in the specification, the claims, and the accompanying drawings of this disclosure are intended to distinguish between different objects, instead of describing a particular sequence. In addition, the term “include” and any variation thereof are intended to cover a non-exclusive inclusion. For example, a process, method, system, product, or device that includes a series of steps or units is not limited to the listed steps or units, but further includes an unlisted step or unit, or further includes another inherent step or unit of the process, the method, the product, or the device. In this disclosure, “a plurality of” may mean at least two, for example, may be two, three, or more. This is not limited in the embodiments of this disclosure.

“And/or” in the embodiments of this disclosure describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

In the technical solutions of this disclosure, collection, propagation, use, and the like of data satisfy national relevant laws and regulations. In the following specific implementation of this disclosure, relevant data of a user and collection of the relevant data are involved. When the embodiments of this disclosure are applied to a specific product or technology, a relevant license or consent needs to be obtained, and collection, use, and processing of the relevant data need to comply with relevant laws, regulations, and standards of relevant countries and regions.

Examples of terms involved in the aspects of the disclosure are briefly introduced. The descriptions of the terms are provided as examples only and are not intended to limit the scope of the disclosure.

Biometric recognition technology: can refer to a technology for determining or authenticating an identity of a target object by analyzing and recognizing a biometric feature of an individual. Common biometric features include a fingerprint, a palm, an iris, a voice, a face, and the like.

Face recognition: can refer to a biometric recognition technology for performing identity authentication and identification by analyzing and recognizing a facial feature of a human body, for example, biometric features such as a facial contour, eyes, a nose, and a mouth.

Palm scanning recognition: can refer to a biometric recognition technology for performing identity authentication and identification by analyzing and recognizing a biometric feature such as a palm print and a palm vein of a palm.

Palm vein: can refer to a feature in a palm that is unique and that can be used for palm scanning recognition, for example, a density, a shape, and a size of veins on the palm.

Palm print: can refer to a feature on a surface of a palm that is unique and that can be used for palm scanning recognition, for example, a texture pattern such as a main line from an end of a finger to a wrist part, a wrinkle, a fine texture, a ridge tip, or a branch point.

Three-dimensional (3D) camera: can refer to an image capturing device for capturing a three-dimensional image, and is usually used in biometric recognition applications such as face recognition and palm scanning recognition. Compared with a related camera, the 3D camera is added with related software and hardware for liveness detection and the like, for example, a depth camera and an infrared camera. The 3D camera may capture images of a target object at different angles and distances, and then calculate a three-dimensional shape and a location of the object by using a built-in sensor and algorithm, to present a more real and three-dimensional effect in the images.

Liveness detection: can refer to a method for determining a real physiological feature of a target object during an identity authentication operation. For example, during a palm scanning recognition operation, whether a palm in an acquired palm image has a biometric feature needs to be verified. For example, whether the palm has a biometric feature such as hemoglobin may be determined by using an image analysis technology.

Language database (Structured Query Language, SQL): can refer to an embedded relational database management system, a lightweight, self-contained, and zero-configuration database engine. SQL is designed in a form of a library, and is statically or dynamically connected to an application, without an independent database server. Therefore, SQL is quite suitable for data storage requirements of an embedded system, a mobile application, and an applet.

Point of interest (POI): can represent a point of interest or a location of interest in a geographic information system, and is usually used in a positioning application to identify a specific geographic location on a map, for example, a shop, an airport, a restaurant, or a park, to provide corresponding location-related information and services for a user.

Artificial intelligence (AI): can refer to a theory, method, technology, and application system that uses a digital computer or a machine controlled by a digital computer to simulate, extend, and expand human intelligence, perceive an environment, acquire knowledge, and use knowledge to obtain an optimal result.

Machine learning (ML): can study how a computer simulates or implements a human learning behavior to obtain new knowledge or skills, and reorganize an existing knowledge structure, so as to keep improving its performance. Machine learning is a core of artificial intelligence, and generally includes technologies such as an artificial neural network, a belief network, reinforcement learning, transfer learning, inductive learning, and learning from demonstrations. In the embodiments of this disclosure, an identification model is trained by using a deep learning method, and then an identity identifier corresponding to a target object is recognized by using the identification model based on a biometric feature transmitted by a biometric recognition apparatus, to obtain identity information of the target object by using the identity identifier.

An intelligent traffic system (ITS) is also referred to as an intelligent transportation system (ITS), and is a comprehensive transportation system that comprehensively applies an information technology, a computer technology, a data communication technology, a sensor technology, an electronic control technology, an automatic control theory, operations research, artificial intelligence, and the like to transportation, service control, and vehicle manufacturing, to enhance a connection between a vehicle, a road, and a user, thereby ensuring safety, improving efficiency, improving an environment, and saving energy.

An intelligent vehicle infrastructure cooperative system (IVICS), a vehicle infrastructure cooperative system for short, is a safe, efficient, and environmentally friendly road traffic system formed by using advanced wireless communication and new-generation Internet technologies to comprehensively implement dynamic vehicle-vehicle and vehicle-infrastructure information interaction in real time and carrying out, based on collection and integration of cross-time-and-space dynamic traffic information, active vehicle safety control and road collaborative management to fully implement effective collaboration between pedestrians, vehicles, and infrastructures, ensure traffic safety, and improve traffic efficiency.

The following briefly describes a design idea of the embodiments of this disclosure.

In an actual application, a biometric recognition technology starts to be introduced to personal identity authentication in more and more application scenarios, to provide a corresponding service function for a target object that passes identity authentication. Compared with a related password recognition technology, the biometric recognition technology performs personal identification by analyzing and recognizing a physiological feature of a human body, can provide an identity authentication result more conveniently, quickly, safely, and reliably, and thus is gradually widely applied to various application scenarios. For example, in an access control scenario, a target object implements an access control unlocking function through a biometric recognition operation. For another example, in a payment scenario, the target object implements a payment function or the like through a biometric recognition operation.

However, in an actual application, if expecting to implement a specific service function through a biometric recognition operation, the target object needs to pre-configure an associated function for a service server with reference to a specific application scenario, so that after the target object passes biometric recognition, the service server can return service information related to the application scenario. It can be learned that this manner limits application and promotion of biometric recognition operations to some extent. To be specific, in one application scenario, the service server usually can feed back only one fixed type of service information, to implement one pre-configured fixed service function.

For example, in the access control scenario, when the target object completes the biometric recognition operation such as face scanning recognition and/or palm scanning recognition via the biometric recognition apparatus, and smoothly passes identity authentication, the biometric recognition apparatus receives a door opening instruction delivered by the service server, and provides an access control unlocking service for the target object.

For another example, in the payment scenario, when the target object completes the biometric recognition operation such as face scanning recognition and/or palm scanning recognition via the biometric recognition apparatus, and smoothly passes identity authentication, the biometric recognition apparatus receives payment information fed back by the service server, and provides an online payment service for the target object.

It can be learned that in the related art, if expecting to implement another service function in a specific application scenario, the target object needs to reconfigure the service server, which leads to complex service operation and maintenance operations and reduces efficiency of service processing. Therefore, how to improve efficiency of implementing a service function based on a biometric recognition operation is a problem to be urgently resolved currently.

In view of the foregoing problem, an embodiment of this disclosure provides a biometric recognition-based service processing method. In the method, a service server intelligently selects at least one piece of matching candidate service information from a service information set based on object description information transmitted by a biometric recognition apparatus and with reference to identity information of a target object that is recorded in a biometric feature and location information of the target object, so that a plurality of service functions can be implemented in a specific application scenario without relying on reconfiguration of the service server. This resolves a technical defect in the related art that only one fixed type of service information is delivered in a specific scenario, reduces service operation and maintenance operations, and improves efficiency of service processing.

On the other hand, the service server transmits the at least one piece of candidate service information to a terminal device associated with the identity information, so that the target object can autonomously select needed target service information from the candidate service information and perform corresponding service processing. In this way, a plurality of personalized services can be provided for different target objects, to meet actual service requirements of the target objects for implementing a plurality of service functions through biometric recognition operations. This improves flexibility and diversity of service processing, and improves user experience while improving the efficiency of service processing.

To further improve the efficiency of service processing and user experience, in this embodiment of this disclosure, candidate service information satisfying a preset matching condition may be further dynamically selected according to scenario types corresponding to different location information and with reference to scenario matching degrees between original service information in the service information set and different scenario types. The service server intelligently selects the candidate service information satisfying the preset matching condition, without manual intervention, so that the efficiency and accuracy of service processing are improved. In addition, the target object is provided with a service function in closer association with a scenario in which the target object is located, so that the target object can enjoy a service that is more personalized and that is close to an actual personal requirement, improving user experience.

To improve efficiency and information security of service processing, in this embodiment of this disclosure, identification or feature matching may be further performed on the obtained biometric feature. In other words, after the biometric feature of the target object is obtained, identity authentication and identification are further performed, including, but not limited to, performing identification on the biometric feature to obtain an identity identifier, or performing matching between the biometric feature and a candidate feature, to obtain the identity information corresponding to the biometric feature more accurately and quickly, thereby preventing a fake identity or misrecognition, improving reliability and precision of biometric recognition, and improving information security of biometric recognition-based service processing as much as possible.

To further improve the information security and the efficiency of service processing, in this embodiment of this disclosure, identification may be performed on the biometric feature by using a trained identification model. The identification model learns association relationships between different biometric features and identity identifiers by using a large amount of sample data, and can more precisely map an input biometric feature to a corresponding identity identifier, to obtain a highly accurate identification result, improving the information security of biometric recognition-based service processing. In addition, the identification model gradually optimizes a parameter setting of the identification model through iterative training, so that when performing identification, the identification model can predict an identity identifier more accurately and quickly. Therefore, identification efficiency of the model is improved, and identification can be performed quickly in a scenario with a high requirement on real-time performance, further improving the efficiency of biometric recognition-based service processing.

To further improve the information security of service processing, in this embodiment of this disclosure, before storing reference service information into the service information set, the service server may perform compliance verification on the reference service information by using a preset information filtering policy, to ensure validity and reliability of the stored new service information, and prevent non-compliant or fake service information from being added to the service information set, thereby ensuring information security of service information obtained by the target object, and improving the information security of service processing.

To further improve user experience, in this embodiment of this disclosure, reference service information may be obtained from each third-party platform via the terminal device, to update the service information set, so that the service information set covers a wider range of service fields and service content, and diversity and richness of service information are improved. Therefore, more service options meeting a personalized requirement of the target object are provided for the target object, and a degree of personalization of a service function and user experience are improved. In addition, the terminal device may perform matching between real-time location information of the target object and preset location information corresponding to a preset scenario type, to accurately obtain a scenario type corresponding to a specific location of the target object. This ensures that the subsequently obtained reference service information highly matches a scenario in which the target object is currently located, and avoids irrelevant or redundant service information being added to the service information set. Therefore, a service function in close association with the scenario in which the target object is located is provided for the target object, improving user experience.

To further improve the information security of service processing, in this embodiment of this disclosure, liveness detection may be additionally performed on the target object when a biometric feature image of the target object is obtained, to ensure that the biometric feature belongs to a real target object rather than being forged, and prevent use of an illegal means of a fake biometric feature such as a photo, improving accuracy and reliability of biometric recognition. In addition, for a palm scanning recognition operation, in this embodiment of this disclosure, feature fusion may be performed on an extracted palm print feature and palm vein feature of the target object, to obtain the biometric feature. Compared with single biometric feature recognition, multi-factor fusion recognition such as palm print and palm vein fusion recognition has higher recognition accuracy and robustness, further improving the accuracy and reliability of biometric recognition, and reducing a misrecognition rate. Therefore, the information security of biometric recognition-based service processing is improved.

After the design idea of the embodiments of this disclosure is described, the following briefly describes an application scenario to which the technical solutions of the embodiments of this disclosure can be applied. The application scenario described below is merely for describing rather than limiting the embodiments of this disclosure. During specific implementation, the technical solutions provided in the embodiments of this disclosure may be flexibly applied based on actual needs.

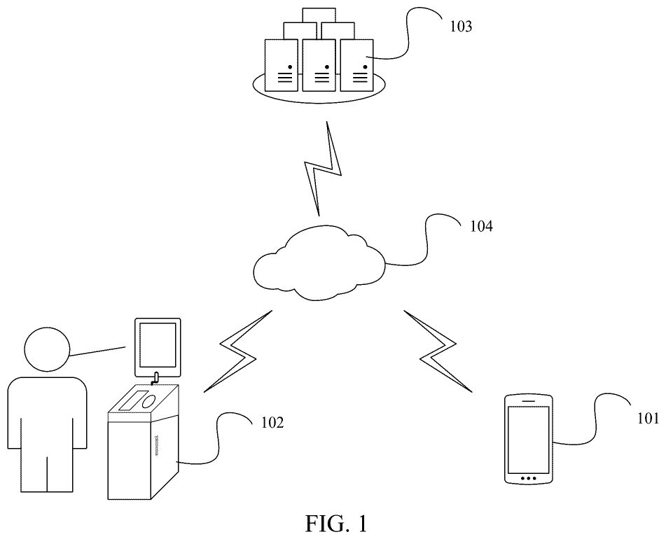

The solutions provided in the embodiments of this disclosure may be applicable to any service processing scenario related to identification performed through a biometric recognition operation, including, but not limited to, a cloud technology, artificial intelligence, intelligent traffic, assisted driving, and the like, for example, a scenario in which online payment, information display, or gate or access control unlocking is implemented through a biometric recognition operation such as palm scanning, face scanning, or pupil verification. FIG. 1 is a schematic diagram of an application scenario according to an embodiment of this disclosure. In the scenario, a terminal device 101, a biometric recognition apparatus 102, and a service server 103 may be included.

The terminal device 101 is any device that is connected to a server and that provides a service for a target object, for example, may be a smartphone, a tablet computer (PAD), a notebook computer, a desktop computer, a smart television, a smart in-vehicle device, a smart voice interaction device, a smart appliance, an in-vehicle terminal, an aircraft, or a smart wearable device. A service processing application corresponding to a service processing system may be installed on the terminal device 101. The service processing application has a function of configuring service information related to identity information for the target object and configuring preset location information and a preset scenario type corresponding to the preset location information, and a function of receiving and viewing a service processing result returned by the server. For example, the service processing application may be a dedicated application corresponding to the service processing system, or may be an application having an equivalent function of the service processing system, such as an instant messaging application, a short video application, a news application, or a shopping application. This is not limited in this embodiment of this disclosure. The application involved in this embodiment of this disclosure may be a software client, or may be a client such as a web page or a mini program. A specific type of the client is not limited.

The biometric recognition apparatus 102 may be a palm scanning gate, a cashier device, a tablet computer, a smartphone, a notebook computer, a desktop computer, a smart appliance, a smart voice interactive device, a smart in-vehicle device, or the like, but is not limited thereto. The biometric recognition apparatus is configured to: during actual service processing, acquire a biometric image of the target object, extract a biometric feature corresponding to the biometric image, and obtain location information of the target object, to obtain object description information of the target object. The biometric recognition apparatus 102 may include an image acquisition apparatus, configured to acquire the biometric image of the target object, such as a palm image or a facial image. The image acquisition apparatus may be a 3D camera, and may further include a communication module matching a communication module in the service server 103, so that the image acquisition apparatus can establish a communication link with the service server 103, to implement a function of transmitting the object description information to the service server.

The service server 103 is a backend processing server corresponding to the service processing system, and provides a corresponding service function for the service processing application, for example, in access control and online payment scenarios, delivers an access control instruction and a payment instruction, or returns service information corresponding to the terminal device.

For example, the service server 103 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform, but is not limited thereto. In addition, the service server 103 may include at least one processor 1031, a memory 1032, an I/O interface 1033 (not shown in the figure) interacting with a terminal, and the like.

In addition, the service server 103 may further configure a service database 1034 (not shown in the figure). The database 1034 may be configured to store the identity information of the target object, a service information set configured in association with the identity information of the target object, a device identifier of the terminal device, a candidate feature, associated identity information, and the like.

The memory 1032 of the server 103 may further store program instructions of the service processing method provided in the embodiments of this disclosure. When the program instructions are executed by the processor 1031, operations of the service processing method provided in the embodiments of this disclosure can be implemented, to perform corresponding service processing.

The terminal device 101, the biometric recognition apparatus 102, and the service server 103 may be directly or indirectly communicatively connected to each other through one or more networks 104. The network 104 may be a wired network, or may be a wireless network. For example, the wireless network may be a mobile cellular network, may be a wireless fidelity (Wi-Fi) network, or certainly may be another network. This is not limited in this embodiment of the present disclosure.

In this embodiment of this disclosure, there may be one or more terminal devices 101, biometric recognition apparatuses 102, and service servers 103. In other words, quantities of the terminal device 101, the biometric recognition apparatus 102, or the service server 103 are not limited.

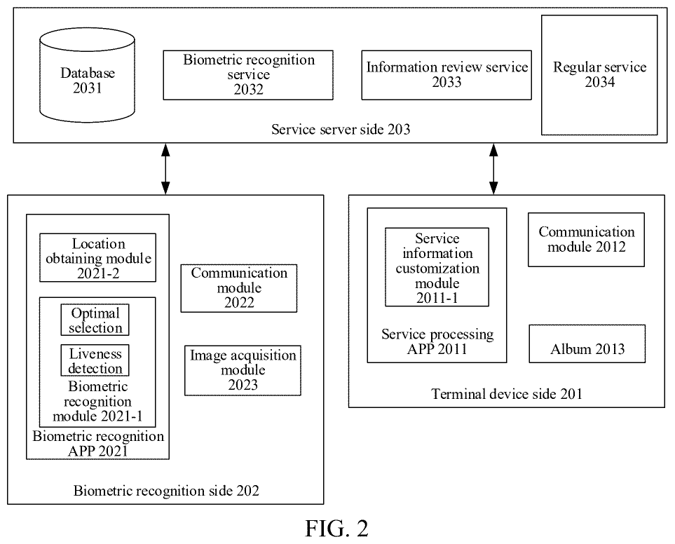

FIG. 2 is a diagram of an architecture of a service processing system according to an embodiment of this disclosure. The architecture may include the following parts.

### (1) Terminal Device Side 201

The terminal device side 201 corresponds to the terminal device 101 in FIG. 1, and is configured to register corresponding identity information for a target object, configure service information related to the identity information, configure preset location information and a preset scenario type corresponding to the preset location information, and receive a service processing result returned by a server. A service processing APP 2011 runs on the terminal device side 201. After a user logs in to the service processing APP 2011, the APP has a login state related to the user. The terminal device side 201 further includes a communication module 2012, configured to be communicatively connected to a service server side 203. The communication module 2012 is, for example, a Bluetooth module, or another communication module.

The service processing APP 2011 mainly carries a service information customization module 2011-1, and the service information customization module 2011-1 is mainly configured to provide a service information binding function. To be specific, the identity information of the target object stored on the service server side 203 and a service information set configured in association with the identity information may be manually configured by the target object via the service information customization module 2011-1. For example, an album 2013 or an image taken on site is uploaded, information obtained by parsing a bar code (a one-dimensional code) or a two-dimensional code in the image is transmitted to the service server side 203 as to-be-configured service information, and the service server 203 configures the service information in association with the identity information of the target object after review succeeds.

### (2) Biometric Recognition Side 202

The biometric recognition side 202 corresponds to the biometric recognition apparatus 102 in FIG. 1. The biometric recognition side 202 has a communication module 2022 matching the service server side 203. A biometric recognition APP 2021 is further installed on the biometric recognition side 202. The biometric recognition APP 2021 can invoke the communication module 2022 to establish a communication connection to the service server side 203, to transmit object description information to the service server side 203 when the target object performs a biometric recognition operation. The biometric recognition APP 2021 may include the following modules:

a biometric recognition module 2021-1, configured to: when the target object performs the biometric recognition operation, invoke an image acquisition module 2023 to acquire biometric image data of the target object, perform optimal selection on the acquired biometric image data, and perform liveness detection, for example, perform comprehensive evaluation by using coefficient indicators such as a size and an angle of a biometric feature in a biometric image, an image contrast, and brightness and a resolution of the image, and select an optimal biometric image; and a location obtaining module 2021-2, configured to: when the target object performs the biometric recognition operation, obtain current location information of the target object, and transmit the location information to the service server side via the communication module 2022.

### (3) Service Server Side 203

The service server side 203 corresponds to the service server 103 in FIG. 1, and provides backend service of the service processing system, including a regular service 2034, a biometric recognition service 2032 for the biometric recognition APP, and a service information review service 2033 for the service processing APP.

The biometric recognition service 2032 is configured to receive the biometric feature and the location information of the target object that are transmitted by the biometric recognition side 202, and perform identification and identity authentication on the target object.

The service information review service 2033 is configured to: receive the service information uploaded by the terminal device side 201, perform information review according to a preset information filtering policy, and configure the service information in association with the identity information of the target object when determining that the service information passes review.

In addition, the service server side is further configured with a related database 2031, configured to store information related to service processing, for example, the identity information of the target object, the service information set configured in association with the identity information of the target object, device identifiers of terminal devices associated with identity information of different target objects, candidate features, and associated identity information. For example, a lightweight database such as structured query language (SQL) may be used for the information. SQL is a relational database management system that complies with ACID (that is, four basic elements of correct execution of a database transaction, that is, atomicity (also referred to as invisibility), consistency, isolation (also referred to as independence), and durability). Therefore, another database or another type of database that can implement a corresponding database function is applicable.

Certainly, in addition to the foregoing several functions, other functions may be further included. This is not limited in this embodiment of this disclosure.

In an actual application, the biometric recognition-based service processing method in the embodiments of this disclosure may be applied to a transportation scenario 1001, a parking scenario 1003, an access control scenario, a check-in scenario, a shopping scenario 1004, and the like.

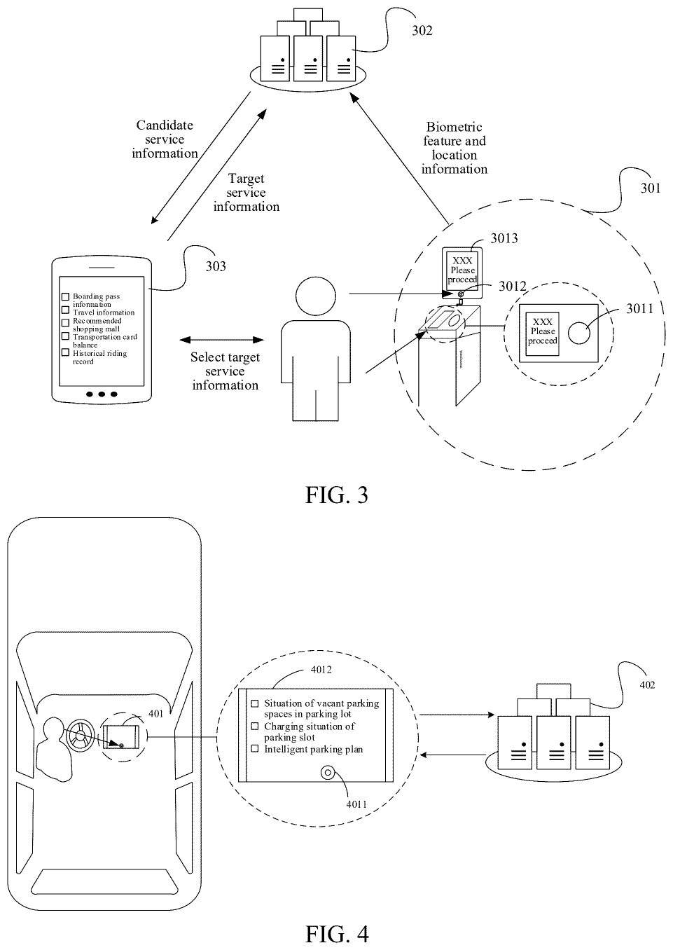

For example, as shown in FIG. 3, in the transportation scenario 1001, an example in which a face/palm scanning gate 301 in an airport, a high-speed rail station, or a subway station is used as a biometric recognition apparatus is used. The face/palm scanning gate 301 includes a palm recognizer 3011, a face recognizer 3012, and a screen for displaying an application interface 3013 including a biometric recognition result.

When passing through the face/palm scanning gate 301, a passenger may place a palm facing the palm recognizer 3011 or align the face with the face recognizer 3012. The face/palm scanning gate 301 acquires a biometric image of the passenger, such as a palm image and a face image, extracts a biometric feature of the passenger based on the biometric image, and transmits the biometric feature and location information of the face/palm scanning gate 301 to a related service server 302.

By using the service processing method provided in the embodiments of this disclosure, the service server 302 obtains, from a service database of the service server based on the biometric feature of the passenger that is received by the service server 302 from the face/palm scanning gate 301, a service information set associated with identity information of the passenger, aggregates and selects, from the service information set, candidate service information matching the location information of the airport, the high-speed rail station, or the subway station at which the passenger is located, and transmits the candidate service information to a terminal device 303 such as a smartphone corresponding to the passenger.

For example, based on location information of an airport at which the passenger is currently located, a plurality of pieces of candidate service information such as travel information such as a boarding pass corresponding to the passenger at the airport, a reserved flight, a hotel, or a car rental, and luggage concession information are selected. For another example, based on location information of a subway station at which the passenger is located, a plurality of pieces of candidate service information such as entertainment recommendation information such as a shopping mall or a tourist attraction near the station, a transportation card balance of the passenger, and a historical riding record are selected.

The passenger may select, via the terminal device 303 of the passenger, target service information needed by the passenger from the plurality of pieces of candidate service information, so that the service server 302 performs corresponding service processing based on the target service information, to provide a needed service function for the passenger.

For another example, as shown in FIG. 4, in an in-vehicle scenario, a vehicle terminal 401 includes an in-vehicle camera 4011 and a screen for displaying an application interface 4012. A face image of a driver is acquired via the in-vehicle camera 4011, a facial biometric feature of the driver is extracted based on the face image, and the facial biometric feature and current location information of a vehicle are transmitted to a related service server 402.

According to the service processing method provided in the embodiments of this disclosure, the service server 402 performs identity authentication on the driver based on the facial biometric feature of the driver that is received by the service server 402. In addition, when the driver passes identity authentication, a service information set associated with identity information of the driver is obtained from a service database, and candidate service information matching a current location scenario is aggregated and selected from the service information set, and is transmitted sent to the corresponding in-vehicle terminal 401, so that the in-vehicle terminal 401 directly displays the candidate service information to the driver by using the application interface 4012 on the screen, or transmits the candidate service information to a terminal device (not shown in the figure) corresponding to the driver, such as a mobile phone.

For example, a current status of the vehicle, a navigation route, a real-time traffic status, a gas station and a service area nearby, and the like are obtained based on the current location information of the vehicle. If the vehicle is currently located near a parking lot, candidate service information such as a situation of vacant parking spaces in the parking lot, parking charging information, and a parking route plan may be further selected for the driver to select. The driver may select, from the candidate service information, target service information needed by the driver, so that the service server 402 performs corresponding service processing, to provide a needed service function for the driver. For example, the driver selects the parking route plan, and the service server may list a quantity of vacant parking spaces in the parking lot and distance information of each parking space, and provide a related parking suggestion for the driver based on service information such as a parking preference of the driver or a fuel level of the vehicle.

For another example, in the conference check-in scenario 1002, a biometric recognition apparatus including a face/palm scanning recognition module is provided. After arriving at a conference site, an attendee may perform conference check-in through face/palm scanning recognition. The biometric recognition apparatus acquires a biometric image of the attendee, such as a face image or a palm image, extracts a corresponding biometric feature, and transmits the biometric feature and location information to a service server. The service server performs, by using the service processing method provided in the embodiments of this disclosure, identity authentication and identification on each attendee with reference to the biometric feature and the location information, to determine that the attendee has qualifications to attend the conference and has arrived at the conference site. In addition, candidate service information in which the attendee may be interested, such as a conference schedule, attendee account information, a conference map and navigation, an exchange forum, information about an exhibitor, and a conference data download, is selected from a service database based on location information (that is, the conference site) and identity information of the attendee, and is transmitted sent to a terminal device of the attendee, such as a smartphone. The attendee views the received candidate service information via the terminal device, and selects the target service information based on an own requirement, for example, selects an account to log in to the conference, view the conference schedule, a conference subject, and a speaker, and logs in to the conference exchange forum. After the attendee selects the target service information, the service server performs corresponding service processing, to provide a needed service for the attendee, for example, adding a selected conference agenda to a personal schedule of the attendee, providing a navigation guidance to a related conference hall, or providing a channel for interacting with the speaker.

In addition, in a specific implementation of this disclosure, relevant data such as a biometric image and a biometric feature of a target object is involved. When the embodiments involved in this disclosure are applied to a specific product or technology, a license or consent of a user needs to be obtained, and collection, use, and processing of the relevant data need to comply with relevant laws, regulations, and standards of relevant countries and regions.

The method provided in the embodiments of this disclosure is not limited to being applied to the application scenario shown in FIG. 4, and may also be applied to other application scenarios. This is not limited in the embodiments of this disclosure. In addition, the components and the structure shown in FIG. 4 are merely exemplary but not limiting. In an actual scenario, there may be other components and structures according to requirements. Functions that can be implemented by the device in the application scenario shown in FIG. 4 are also described in subsequent method embodiments. Details are not described herein.

The following describes the service processing method provided in exemplary implementations of this disclosure with reference to the foregoing application scenarios and system architecture and the accompanying drawings. The foregoing application scenarios are merely shown for ease of understanding the spirit and principle of this disclosure, and the implementations of this disclosure are not limited in this aspect.

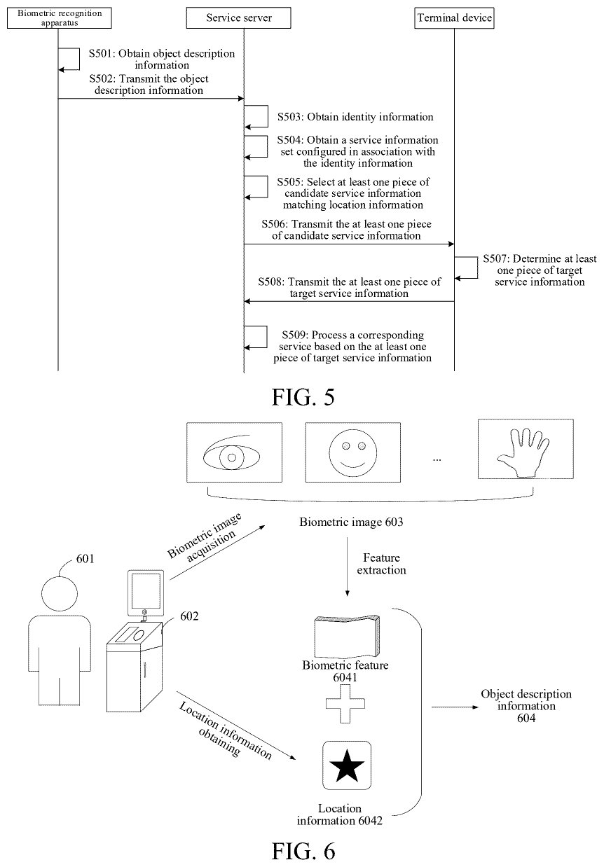

FIG. 5 is a schematic flowchart of interaction in a service processing method according to an embodiment of this disclosure. A procedure of the method is described as follows.

Operation 501: A biometric recognition apparatus obtains object description information of a target object.

Operation 502: The biometric recognition apparatus transmits the object description information to a service server corresponding to a service processing system.

In this embodiment of this disclosure, the object description information of the target object includes a biometric feature and location information of the target object. The biometric feature is configured for uniquely identifying and recognizing identity information of the target object. The location information is configured for indicating a current geographic location or spatial environment of the target object. The biometric recognition apparatus recognizes and obtains the biometric feature of the target object and the location information of the target object, and transmits the biometric feature and the location information to the corresponding service server, to implement a subsequent service processing procedure.

In an implementation, the biometric recognition apparatus may obtain a biometric image of the target object in response to a biometric recognition operation triggered by the target object, extract the biometric feature included in the biometric image, and obtain the object description information of the target object based on the current location information of the target object and the biometric feature.

In some aspects, the biometric recognition operation includes, but is not limited to, a face recognition operation, a palm scanning recognition operation, a pupil recognition operation, and the like. Correspondingly, the biometric recognition apparatus may include, but is not limited to, a face recognition instrument, a palm print recognition instrument, a pupil recognition instrument, and another apparatus.

As shown in FIG. 6, when a target object 601 aligns a face, a palm, and eyes of the target object with a biometric recognition apparatus 602, the biometric recognition apparatus 602 may obtain a biometric image 603 of the target object, such as a face image, a palm image, and a human eye image, via an image acquisition apparatus of the biometric recognition apparatus 602, and extract a biometric feature 6041 of the target object, such as a facial feature, a palm print, and an iris. In addition, the biometric recognition apparatus is configured with a positioning apparatus such as a global positioning system (GPS), a Wi-Fi positioning apparatus, or a Bluetooth positioning apparatus, configured to obtain coordinates of the target object, an area identifier, or other location information 6042 with a detailed location description. This is not limited in this embodiment of this disclosure. The biometric feature 6041 and the location information 6042 jointly form object description information 604.

In an implementation, the biometric feature extracted by the biometric recognition apparatus from the biometric image may be a biometric feature obtained by performing feature extraction on the biometric image, and may be the biometric image, for example, numerical information of each color channel of a biometric image of a face, a palm, or a finger or information such as a grayscale and brightness of the biometric image; may be a feature obtained by processing the biometric image in an image processing manner, for example, performing binarization on the image; or may be an image feature obtained by performing feature extraction on the biometric image by using an artificial neural network model trained based on deep learning methods.

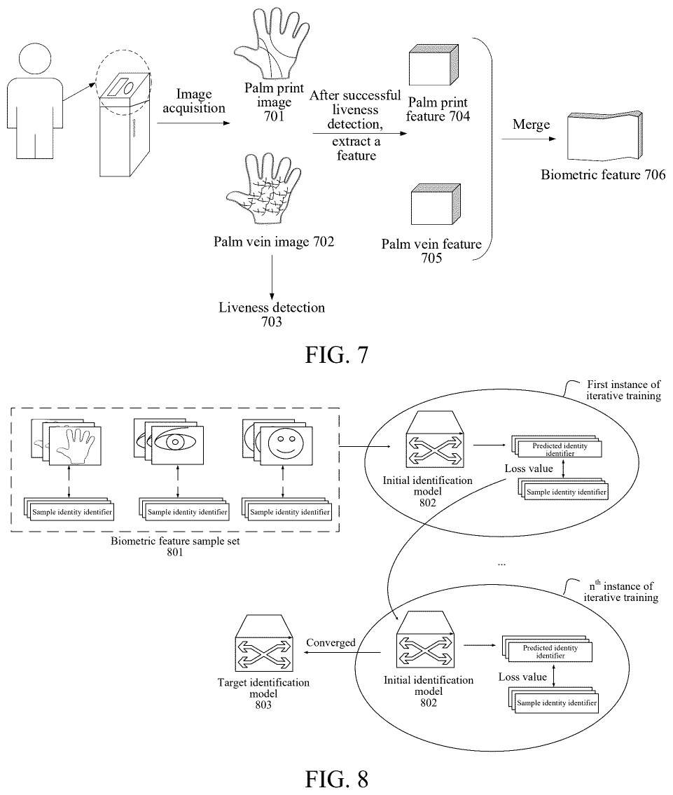

In an implementation, as shown in FIG. 7, an example in which the palm scanning recognition operation is the biometric recognition operation triggered by the target object is used. The biometric recognition apparatus may acquire, in response to the palm scanning recognition operation triggered by the target object, a palm image set of the target object that includes a palm print image 701 and a palm vein image 702, to extract a biometric feature from the palm image set. In addition, liveness detection 703 is performed on the target object by using the palm vein image 702 in the palm image set, to ensure that the acquired palm image set belongs to the real target object and that illegal biometric recognition is not performed by using a fake biometric feature such as a forged photo. Therefore, accuracy and reliability of biometric recognition are improved.

After the target object passes liveness detection, the biometric recognition apparatus may extract a palm print feature 704 in the palm print image and a palm vein feature 705 in the palm vein image in the palm image set, and merge the palm print feature 704 and the palm vein feature 705, that is, performs feature fusion, to obtain a biometric feature 706 of the target object.

Compared with single biometric feature recognition, palm print and palm vein multi-factor fusion recognition has higher recognition accuracy and robustness, further improving the accuracy and reliability of biometric recognition, and reducing a misrecognition rate. Therefore, information security of biometric recognition-based service processing is improved.

In some aspects, palm scanning recognition is a technology for obtaining identity information by using multimedia information of a palm. When identity authentication needs to be performed during execution of a service, the palm scanning recognition operation is an operation performed by the target object to provide information required for identity authentication when identity authentication is performed in a palm scanning recognition manner.

The palm scanning recognition operation is usually performed in a manner that the target object places a palm of the target object within a region of a recognition range in which a biometric feature can be acquired on a biometric recognition apparatus having a palm scanning function, so that the biometric recognition apparatus acquires a palm image set for a subsequent identification process. The palm image set may include, but is not limited to, a palm vein image, a palm print image, a palm red green blue (RGB) image, and the like. The palm vein image may be a vein image of a palm center or a vein image of a palm back. The palm print image may be a palm print image of the palm center or a palm print image of the palm back. The palm RGB image may be an RGB image of the palm center or an RGB image of the palm back.

In an implementation, the image acquisition apparatus in the biometric recognition apparatus may be configured with a 3D camera, configured to acquire a 3D biometric image of the target object. The 3D camera mainly includes a color sensor (that is, an RGB sensor) and an infrared sensor (that is, an IR sensor). The color sensor is configured to take a color image. The infrared sensor is configured to take an infrared image, and is configured to perform liveness detection, that is, identify whether the target object is a live target object.

The palm scanning recognition operation is as an example. The biometric recognition apparatus may acquire an infrared palm vein image of the target object by using the infrared sensor, perform liveness detection to determine whether the target object is a real living body by analyzing a feature such as a blood flow in the infrared palm vein image, and continue subsequent processing if the target object passes liveness detection, or rejects the palm scanning recognition operation of the target object if the target object does not pass liveness detection.

After the target object passes liveness detection, the biometric recognition apparatus recognizes and extracts the palm print feature such as a texture, a print line, and a branch point of a palm print in the palm print image by using an image processing algorithm, and processes and analyzes the feature in the palm vein image such as information of a distribution, a shape, and the like of a vascular network of the palm by using the infrared image.

After obtaining the palm print feature and the palm vein feature of the target object, the biometric recognition apparatus may fuse (or merge) these features. Different algorithms may be used for fusion, such as feature-level fusion and decision-level fusion. The two types of biometric feature information are combined to generate a fused biometric feature for subsequent identity authentication and service processing, so that precise biometric recognition and personalized services are implemented.

Operation 503: The service server obtains the identity information of the target object that is recorded in the biometric feature.

In this embodiment of this disclosure, the service server obtains, by using the object description information transmitted by the biometric recognition apparatus, the identity information recorded in the biometric feature, and obtains, from a database or another resource, a service information set related to the identity information.

In an implementation, to improve efficiency and security of service processing, in this embodiment of this disclosure, identity identification may be performed on the biometric feature to obtain an identity identifier corresponding to the biometric feature, and then the identity information associated with the identity identifier is determined.

In this way, the identity information corresponding to the identity identifier can be quickly and accurately obtained, to prevent a fake identity or misrecognition, improve reliability and precision of biometric recognition, and improve information security of biometric recognition-based service processing.

In some aspects, an identity identifier represents an identity of a different target object in the service processing system, and for example, may be indicated by a unique identifier such as an account ID and an identity card number. Identity identification is a process of determining, by analyzing, verifying, and matching the biometric feature of the target object, the identity identifier matching the biometric feature of the target object. Through identity identification, the service server may associate the abstract biometric features with the specific identity identifier, to obtain the corresponding identity information from the database or the another resource of the service server based on an association relationship between the identity identifier and the identity information. For example, an identity of the target object is recognized and authenticated by analyzing and matching key feature points such as locations of eyes, a nose, and a mouth in a face image, a pattern, details, and feature points of a fingerprint, uniqueness of an iris texture, a voice feature and a spectrum of a voice, a pattern and feature points of a palm, and a vein image of a part such as a finger and the palm.

In an implementation, to improve the efficiency of service processing, identification may be performed by using a trained identification model.

In this embodiment of this disclosure, the identification model learns and distinguishes fine feature differences between target objects from a large amount of data by using a deep learning method based on a multi-layer structure of a convolutional neural network (CNN), thereby implementing more accurate identification. For example, the identification model is MobileNets, ResNet, DenseNet, or the like.

The following describes a process of training the identification model by using sample data, including the following operations:
obtaining the sample data, the sample data including a plurality of sample identity identifiers and sample biometric features respectively corresponding to the plurality of sample identity identifiers; and performing, based on the sample data, iterative training on an initial identification model to be trained, to obtain the trained identification model, each iterative training process including the following operations:
predicting, by using the initial identification model, a sample biometric feature input for a current iteration, to obtain a predicted identity identifier of the sample biometric feature;
determining a difference between a sample identity identifier corresponding to the sample biometric feature and the predicted identity identifier as a loss value; and
adjusting a parameter of the initial identification model based on the loss value.

In some aspects, an example in which a classification model is used as the identification model is used. As shown in FIG. 8, in this embodiment of this disclosure, a large-scale biometric feature sample set 801 is used to train an initial identification model 802, so that the initial identification model 802 can learn richer and generalized feature representations, to finally obtain a target identification model 803.

A plurality of sample biometric features in the biometric feature sample set 801 are respectively tagged with corresponding sample identity identifiers in advance, and then binary classification training is performed on the initial identification model 802 by using tagged sample data.

In the training process, some key parameters need to be set, and setting quality of these parameters directly affects a model effect. In this embodiment of this disclosure, values of the key parameters may be obtained in a grid search manner. In addition, during model training, a regular term coefficient is set to prevent overfitting, thereby improving a generalization capability of the model. For example, the parameters include weights used in a convolutional layer, a fully connected layer, and a softmax layer.

In the training process, the loss value is configured for representing the difference between the sample identity identifier corresponding to the sample biometric feature and the predicted identity identifier, and model training is to minimize the difference between the sample identity identifier and the predicted identity identifier. Whether the identification model converges is determined based on the loss value. When it is determined that the identification model does not converge, the model parameter of the identification model is adjusted based on the loss value, and a next round of training is performed by using the identification model with an adjusted parameter; or when it is determined that the identification model converges, training is ended, and the trained identification model is output. Certainly, in this embodiment of this disclosure, when a quantity of times of iterative pretraining reaches a preset quantity of times, training is ended, and the trained identification model is output. This is not limited in this disclosure.

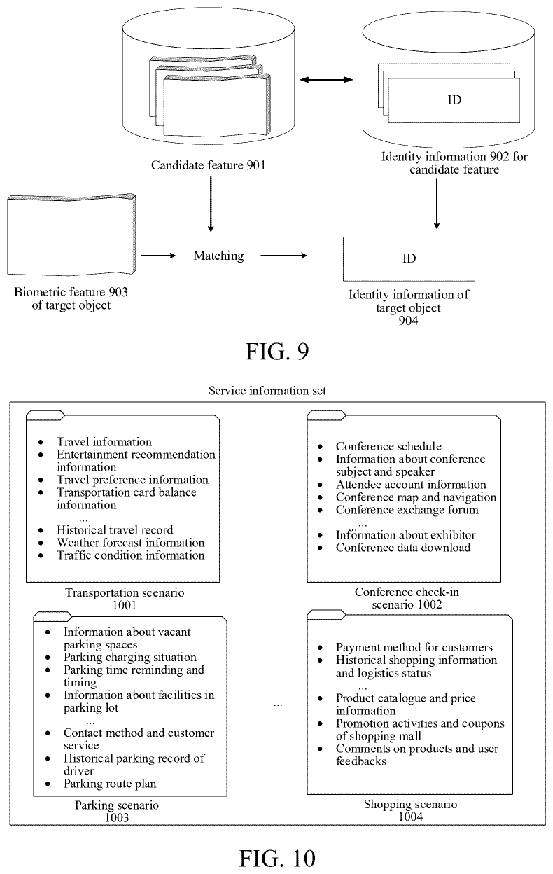

In an implementation, as shown in FIG. 9, to improve efficiency and security of service processing, in this embodiment of this disclosure, feature matching may be further performed between at least one prestored candidate feature 901 and a biometric feature 903 of the target object. Identity information 902 associated with a successfully matched candidate feature is used as identity information 904 of the target object.

In some aspects, when receiving the biometric feature of the target object transmitted by the biometric recognition apparatus, the service server performs matching between the biometric feature and a prestored candidate feature, including, but not limited to, evaluating a similarity between the biometric feature and the candidate feature by using various feature matching algorithms such as feature vector similarity calculation and pattern matching. When matching succeeds, that is, a similarity between the biometric feature and a candidate feature exceeds a preset threshold, the service server uses identity information associated with the candidate feature as the identity information of the target object.

In some aspects, the target object may upload the biometric feature of the target object to the service server in advance through an identity registration operation. The service server associates biometric features uploaded by different target objects with identity information of the target objects, and stores the biometric features and the identity information in the database of the target object. For example, each candidate feature may be a palm feature that corresponds to each target object and that includes palm print and palm vein information, and correspondingly, the identity information may include a personal name, an identity card number, and the like of each target object.

Operation 504: The service server obtains the service information set configured in association with the identity information.

In this embodiment of this disclosure, when obtaining the identity information of the target object by using the biometric feature, the service server may obtain, based on a mapping relationship between identity information and a service information set, the service information set configured in association with the identity information.

In an implementation, the service information set may include, but is not limited to, service information such as historical service records, service preference settings, function configurations, or function options related to the target object in a plurality of service scenarios, and different service information may be used to provide the target object with different service functions in corresponding service scenarios.

In some aspects, as shown in FIG. 10, four service scenarios are used as an example: a transportation scenario 1001, a conference check-in scenario 1002, a parking scenario 1003, and a shopping scenario 1004. The service information set configured in association with the identity information of the target object may include a plurality of types of service information respectively corresponding to the four service scenarios.

For example, in the transportation scenario 1001, the service information set may include travel information such as a boarding pass, flight information, hotel booking information, car booking information, and baggage concession information, entertainment recommendation information such as a shopping mall and a tourist attraction, travel preference information such as a common transportation tool, and service information such as transportation card balance information, a historical travel record, a weather forecast, and a traffic condition.

In the conference check-in scenario 1002, the service information set may include service information such as a conference arrangement, information about a conference subject and a speaker, attendee account information, a conference map and navigation, a conference exchange forum, information about an exhibitor, and a conference data download.

In the parking scenario 1003, the service information set may include service information such as information about vacant parking spaces, a parking charging status and a payment method, parking time reminding and timing, information about facilities in a parking lot (such as an automatic car washing machine and a charging stake), stipulation and traffic care of the parking lot, a contact method and a customer service of the parking lot, a historical parking record of a driver, and a parking route plan.

In the shopping scenario 1004, the service information set may include service information such as a payment manner for customers, historical shopping information and a logistics status, a product catalog and price information, shopping promotion activities and coupons of a shopping mall, and comments on products and user feedbacks.

The service server may provide different service functions for the target object based on different service information, for example, service functions of automatically displaying the boarding pass based on the flight information, recommending information about a nearby store based on the hotel booking information, displaying a transportation card balance, performing a conference check-in for the target object, and recommending a parking route for the target object.

In an implementation, to enable the service information set to cover richer service fields and service functions, diversity and richness of the service information are improved, to provide a service option that better meets a personalized requirement of the target object, improving user experience.

In this embodiment of this disclosure, a terminal device may obtain real-time location information of the target object in real time, and perform matching between the real-time location information and preset location information corresponding to a preset scenario type, to precisely obtain a scenario type corresponding to a specific location of the target object. When matching succeeds, reference service information is obtained, from a third-party platform associated with the corresponding preset scenario type, based on the preset scenario type corresponding to the preset location information, and then the reference service information is transmitted to the service server, so that the service server stores the reference service information into the service information set as new original service information, to ensure that the obtained reference service information highly matches a scenario in which the target object is currently located, and avoid irrelevant or redundant service information being added to the service information set. Therefore, the service server provides a service function in close association with the scenario in which the target object is located, improving user experience.

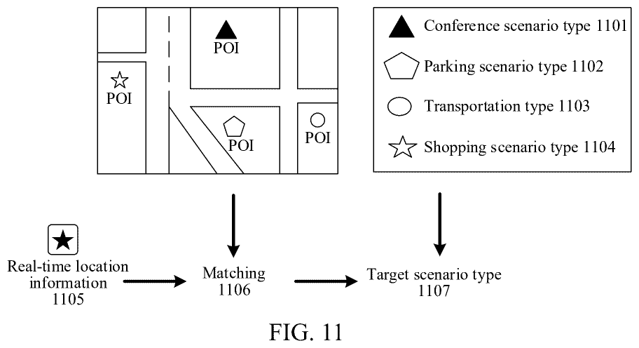

In some aspects, as shown in FIG. 11, the preset location information represents geographic coordinates or a regional range in which a specific scenario type occurs, and may be preset by presetting a POI at a specific geographic location. The POI represents that the location information is of special interest or importance to the target object. The preset scenario type is a specific type of activity or situation that is predicted to possibly occur at the specific geographic location such as the POI.

For example, a geographic location such as a mall, a shopping center, a shopping street, a restaurant, a hotel, or a scenic spot may be set as a POI corresponding to a shopping scenario type 1104. A geographic location such as an underground parking lot, a road-side parking space, or an indoor parking lot may be set as a POI corresponding to a parking scenario type 1102. A geographic location such as an exhibition hall, a conference center, or a conference room may be set as a POI corresponding to a conference scenario type 1101. A geographic location such as a railway station, a high-speed rail station, an airport, a bus stop, or a metro station and may be set as a POI corresponding to a transportation type 1103.

In an actual application, the terminal device may obtain real-time location information (for example, longitude and latitude values) 1105 of the target object, to determine a geographic location of the target object, and perform matching 1106 between the real-time location information 1105 and preset POI data, to determine a target scenario type 1107 in which the target object is located, thereby learning whether the target object is located near or inside a specific POI.

The preset shopping scenario 1004 is used as an example. The shopping scenario type 1104 may be pre-associated with preset location coordinates corresponding to POIs such as the shopping center, the shopping street, and a playground. The terminal device carried by the target object obtains, in real time, current location coordinates of the target object, and compares the location coordinates with preset location coordinates of each POI. When a coordinate similarity between the location coordinates of the target object and the location coordinates of the POI is greater than a preset threshold, it is determined that the target object is currently located near or inside the POI, so that the shopping scenario type 1104 corresponding to the POI is used as the scenario type in which the target object is located.

In an implementation, when the preset scenario type corresponding to the preset location information is obtained, the reference service information may be obtained from the third-party platform corresponding to the preset scenario type by using a preset mapping rule between each preset scenario type and a third-party platform related to the preset scenario type. The mapping rule may be formulated based on historical sources of historical service information corresponding to different scenario types and service requirements.

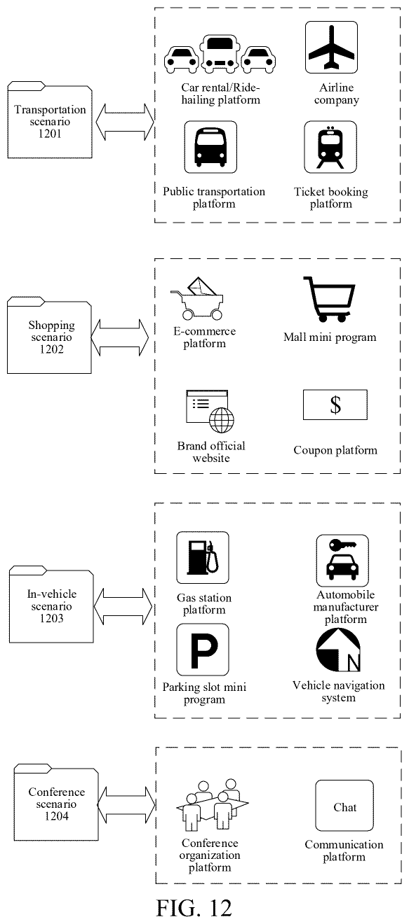

As shown in FIG. 12, a type of a transportation scenario 1201 may be associated with a third-party platform such as a public transportation platform, a car rental/ride-hailing platform, or an air ticket/train ticket/high-speed rail ticket booking. A type of a shopping scenario 1202 is associated with a third-party platform such as an e-commerce platform, a mall mini program, a brand official website, or a coupon. An in-vehicle scenario 1203 may be associated with a third-party platform such as a vehicle navigation system, a gas station platform, an automobile manufacturer platform, or a parking lot mini program. A conference scenario 1204 may be associated with a third-party platform such as a conference organization platform or a communication platform having a code scanning check-in function.

In some aspects, the target object may perform an authorization operation on the terminal device in advance, to allow a service processing APP on the terminal device to access each third-party application and obtain specific service information, thereby ensuring legal use and information security of the service information. At least one third-party platform corresponding to each scenario type may be recorded in the database.

When the preset scenario type matching the real-time location information of the target object is determined, the service processing APP on the terminal device may find, based on the record in the database, a third-party platform list associated with the preset scenario type, and invoke a corresponding API to obtain reference service information related to the preset scenario type from each third-party platform. The API may be invoked according to an interface specification of each third-party platform.

Finally, the reference service information obtained from each third-party platform is integrated, processing such as selection and sorting is performed based on a requirement, and processed reference service information is transmitted to the service server.

In an implementation, when obtaining the reference service information from the third-party platform, the terminal device may obtain the reference service information related to the preset scenario type in a plurality of methods such as API invocation, keyword matching, and data filtering, to ensure that the obtained reference service information highly matches the scenario in which the target object is located, and avoid irrelevant or redundant service information being added to the service information set.

In some aspects, a specific API may be invoked to request adapted reference service information. The API provided by the third-party platform may allow the terminal device to transmit a request of a specific type to the third-party platform, to obtain service information in a specific scenario. For example, when the preset scenario type is a food-and-beverage scenario type, an API of a delicacy comment platform may be invoked to request reference service information such as comments, menus, and addresses of nearby restaurants. Alternatively, massive data of the third-party platform may be searched for a keyword related to the preset scenario type, and adapted reference service information is obtained through keyword matching. For example, when the preset scenario type is a scenic spot scenario type, the terminal device may search for information including a keyword such as “scenic spot” or “travel”, to obtain service information related to the scenic spot. In addition, the terminal device may further select the service information related to the preset scenario type by setting a specific filter condition. For example, when the preset scenario type is the type of the shopping scenario 1004, reference service information such as a nearby shopping mall, a shopping discount, and a brand promotion may be selected.

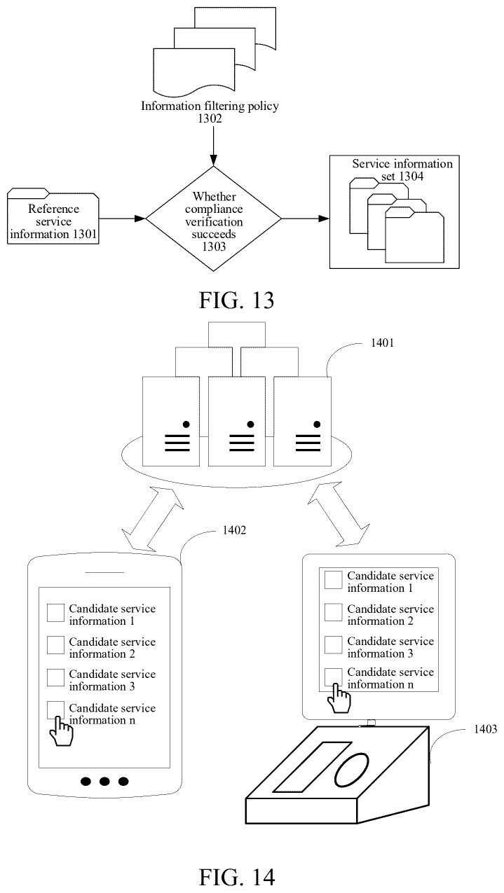

In an implementation, as shown in FIG. 13, to improve information security of service processing, when receiving reference service information 1301 transmitted by the terminal device, the service server may perform compliance verification 1303 on the reference service information by using a preset information filtering policy 1302, and when the reference service information passes verification, store the reference service information into a service information set 1304 as new original service information. In this way, noncompliant or fake service information can be prevented from being added to the service information set, and information security of the service information obtained by the target object can be ensured.

In some aspects, the information filtering policy may identify a sensitive word, phrase, or pattern in the reference service information, to determine whether the reference service information includes noncompliant content, and intercept illegal or noncompliant reference service information. The information filtering policy includes, but is not limited to:
(1) a keyword-based filtering policy: Matching is performed between a preset keyword and text information in the reference service information, to identify whether the reference service information includes sensitive content;
(2) a part-of-speech tagging-based filtering policy: Word segmentation and part-of-speech tagging are performed on text information in the reference service information, to determine, according to a predefined rule, whether there is noncompliant, and compared with the keyword-based filtering policy, this policy is complex, but can identify noncompliant content more accurately;
(3) a machine learning-based filtering policy: A model is trained by using a machine learning algorithm, to identify noncompliant content in the reference service information, which generally needs a large amount of training data and manual annotations, and can adapt to constantly changing noncompliant content;
(4) a hybrid filtering policy: a plurality of filtering policies, including, but not limited to, the foregoing, are combined, to improve detection accuracy and adaptability of information filtering; and
(5) a manual review policy: To avoid missing detection and misinformation, measures such as manual review may be combined with the foregoing filtering policies, to further ensure compliance of the reference service information.

Operation 505: The service server selects, from the service information set, at least one piece of candidate service information matching the location information.

Operation 506: The service server transmits the at least one piece of candidate service information to the terminal device associated with the identity information.

In this embodiment of this disclosure, when obtaining the service information set associated with the identity information, the service server selects the at least one piece of candidate service information matching the location information of the target object from a large amount of service information in the service information set as target service information, and returns the target service information to the terminal device associated with the identity information, so that the target object triggers a selection operation to perform a subsequent service processing procedure.

In this embodiment of this disclosure, the terminal device and the biometric recognition apparatus may be two independent devices as described above, each having a different function, or may be an integrated device integrating functions of the terminal device and the biometric recognition apparatus, to implement all functions related to the terminal device and the biometric recognition apparatus. Therefore, the service server may transmit the candidate service information to the terminal device; or may return the candidate service information to the integrated device integrating the functions of the biometric recognition apparatus and the terminal device, so that the target object triggers a candidate selection operation via the integrated device.

For example, in the in-vehicle scenario, an in-vehicle terminal is the integrated device integrating the terminal device and the biometric recognition apparatus, and has all the functions related to the biometric recognition apparatus and the terminal device. The in-vehicle terminal is provided with a camera, and may perform face recognition on the target object such as the driver to obtain the biometric feature of the target object, obtain the location information of the target object by using an in-vehicle GPS, to obtain the object description information of the target object, wirelessly transmit the object description information to the service server corresponding to the service processing system, receive the candidate service information returned by the service server, and display the candidate service information on an in-vehicle display screen corresponding to the in-vehicle terminal, for the target object to select the target service information from the candidate service information, thereby implementing the subsequent service processing procedure.

In an implementation, the target scenario type corresponding to the location information may be obtained, to calculate a scenario matching degree between each piece of original service information included in the service information set and the target scenario type. In this way, whether the scenario matching degree satisfies a preset matching condition is determined, to select the at least one piece of candidate service information satisfying the condition from each piece of original service information.

In some aspects, the scenario matching degree between the original service information and the target scenario type may be calculated in the following manner.

(1) Text matching manner: Text information such as a text description, a keyword, or a tag in the original service information is analyzed, and is semantically compared with the target scenario type, to calculate a semantic matching degree between the text information and the target scenario type.

Alternatively, a matching degree in text information between the original service information and the target scenario type is calculated by using a natural language processing technology. For example, a word vector model such as a word embedding model (Word2Vec) or a bidirectional encoder (Bidirectional Encoder Representations from Transformers, BERT) is used to represent texts of the original service information and the target scenario type, and a cosine similarity or a Euclidean distance between the texts is calculated.

(2) geographic matching manner: Whether a target location and a location associated with each piece of service information are within a same geographic region or geographic feature is determined by using geographic information system (GIS) data such as geographic coordinates, a geographic boundary, and a geographic feature.

Alternatively, a distance or similarity between a target location of the target object and a location associated with each piece of service information is calculated, to perform matching between the service information and the location information. For example, a distance between the location information and location information associated with each piece of service information in the service information set is calculated by using a metric manner such as a Euclidean distance, a Manhattan distance, or a cosine similarity. A smaller distance indicates a higher similarity and a higher matching degree between the service information and the location information.

(3) Location classification manner: A corresponding preset scenario type is preset for each piece of original service information in the service information set, and may be set by using a tag or a scenario category. A matching degree in type similarity between the target scenario type and the preset scenario type corresponding to each piece of original service information is calculated.

For example, the matching degree is measured by using an intersection between tags or a Jaccard similarity coefficient (Jaccard similarity).

(4) Model matching manner: A model is trained based on historical matching data by using a machine learning algorithm such as a classification model, a regression model, or a neural network, to predict a matching degree between the target scenario type and the service information.

In some aspects, when the scenario matching degree between each piece of original service information and the target scenario type is calculated, a magnitude relationship between each scenario matching degree and a preset matching degree threshold may be obtained through comparison. When it is determined that a scenario matching degree between a piece of original service information and the target scenario type is not less than the preset matching degree threshold, it is determined that the scenario matching degree satisfies the preset matching condition, so that the original service information is used as the candidate service information.

Operation 507: The terminal device determines at least one piece of target service information from the at least one piece of candidate service information in response to a selection operation triggered by the target object.

Operation 508: The terminal device transmits the at least one piece of target service information to the service server.

In this embodiment of this disclosure, as shown in FIG. 14, after receiving the at least one piece of candidate service information transmitted by the service server, the terminal device may notify the target object, and display related candidate service information to the target object. The target object may browse the candidate service information on the terminal device, and select the at least one piece of target service information needed by the target object, so that the terminal device returns the target service information selected by the target object to the service server.

In some aspects, an example in which a shopper in a shopping scenario of a shopping mall is the target object is used. A service server 1401 selects candidate service information 1, 2, 3, . . . , and n related to the shopping scenario, and transmits the candidate service information 1, 2, 3, . . . , and n to a terminal device 1402 such as a smartphone used by the shopper or a biometric recognition device 1403 used by the shopper. The candidate service information 1, 2, 3, . . . , and n includes, but is not limited to, candidate service information such as information about different stores in the shopping mall, information about an activity in the shopping mall, and a location of a toilet in the shopping mall. The terminal device 1402 such as the smartphone of the shopper may display a candidate service information list on a screen of the terminal device 1402 in a manner of a pop-up window. The shopper may select target service information in which the shopper is interested from the candidate service information list, so that the terminal device returns the target service information selected by the shopper to the service server. The target object is allowed to select, based on personal preferences and requirements, the target service information in which the target object is interested from a plurality of pieces of candidate service information, so that shopping experience of the shopper and convenience in shopping are improved.

Operation 509: The service server receives the at least one piece of target service information returned by the terminal device, and processes a service corresponding to each piece of target service information in the at least one piece of target service information.

In this embodiment of this disclosure, the terminal device transmits the target service information selected by the target object to the service server, so that the service server can learn a service requirement of the target object, and perform corresponding service processing based on the target service information. In this way, a plurality of personalized services can be provided for different target objects, to meet actual service requirements of the target objects for implementing a plurality of service functions through biometric recognition operations. This improves flexibility and diversity of service processing, and improves user experience of the target objects while improving the efficiency of service processing.

In some aspects, an example in which a passenger in the transportation scenario is the target object is used. The passenger may select at least one piece of target service information needed by the passenger based on a plurality of pieces of candidate information displayed on the terminal device, such as boarding pass information, travel information, information about a recommended shopping mall, transportation card balance information, and a historical riding record. The service server performs a corresponding service operation based on the target service information selected by the passenger.

When the passenger selects the boarding pass information, the service server may generate an electronic boarding pass of the passenger, including information such as flight information, a seat number, and a boarding time, and transmit the electronic boarding pass to the terminal device of the passenger, to improve travel experience of the passenger and convenience in travel.

When the passenger selects the travel information, the service server generates a detailed schedule based on information such as a travel schedule of the passenger, including information such as a departure time, a transportation manner, and a destination, and provides real-time traffic information, to help the passenger avoid a congested road section, improving travel experience of the passenger.

When a passenger selects the information about the recommended shopping mall, a nearby shopping mall or shopping center is recommended based on a current location and a historical preference of the passenger, a shopping mall map and navigation are provided to help the passenger find a shop of interest quickly, and information about a promotion activity and a coupon in the shopping mall are pushed.

When the passenger selects the transportation card balance information, the service server may display a balance and a use record of a transportation card associated with the passenger, prompt the passenger to recharge in time based on the balance, and provide a nearby recharging point and a location of an automatic ticket vending machine, to ensure that the passenger can normally take a bus, improving travel experience of the passenger.

When the passenger selects the historical riding record, the service server aggregates historical riding records of the passenger, including start and stop stations, riding time, and the like, and collects statistics on and analyzes a travel habit of the passenger, to plan a better travel solution and route for the passenger, improving travel experience of the passenger.

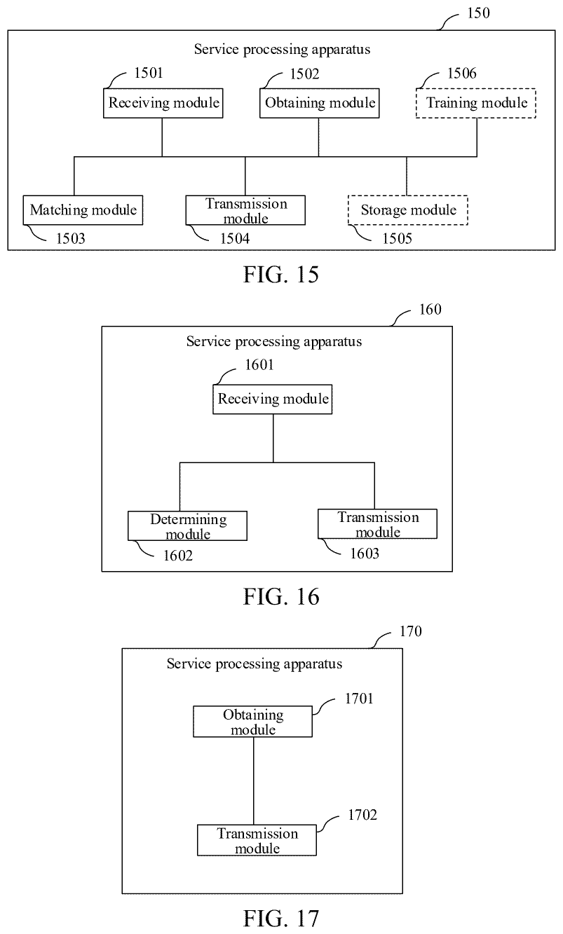

Refer to FIG. 15. Based on a same inventive concept, an embodiment of this disclosure further provides a service processing apparatus 150, applied to a service server in a service processing system. The apparatus includes:

a receiving module 1501, configured to receive object description information transmitted by a biometric recognition apparatus, the object description information including a biometric feature and location information of a target object;
an obtaining module 1502, configured to: obtain identity information of the target object that is recorded in the biometric feature, and obtain a service information set configured in association with the identity information;

a matching module 1503, configured to select, from the service information set, at least one piece of candidate service information matching the location information; and

a transmission module 1504, configured to transmit the at least one piece of candidate service information to a terminal device associated with the identity information, the terminal device determining at least one piece of target service information from the at least one piece of candidate service information in response to a selection operation triggered by the target object; and the receiving module 1501 being further configured to: receive the at least one piece of target service information returned by the terminal device, and process a service corresponding to each piece of target service information in the at least one piece of target service information.

In some embodiments, the service information set includes a plurality of pieces of original service information. The matching module 1503 is configured to:
obtain a target scenario type corresponding to the location information;
obtain a scenario matching degree between each of the plurality of pieces of original service information and the target scenario type; and
determine at least one piece of original service information whose scenario matching degree satisfies a preset matching condition as the at least one piece of candidate service information.

In some embodiments, the obtaining module 1502 is configured to:
perform identification on the biometric feature to obtain an identity identifier corresponding to the biometric feature; and
determine the identity information associated with the identity identifier.

In some embodiments, the obtaining module 1502 is configured to:
perform matching between at least one prestored candidate feature and the biometric feature; and
use identity information associated with a successfully matched candidate feature as the identity information.

In some embodiments, identification is performed by using a trained identification model. The apparatus further includes a training module 1506, configured to:
obtain sample data, the sample data including a plurality of sample identity identifiers and sample biometric features respectively corresponding to the plurality of sample identity identifiers; and
perform iterative training on an initial identification model based on the sample data, to obtain the trained identification model, each iterative training process including the following operations:
predicting, by using the initial identification model, a sample biometric feature input for a current iteration, to obtain a predicted identity identifier of the sample biometric feature;
determining a difference between a sample identity identifier corresponding to the sample biometric feature and the predicted identity identifier as a loss value; and
adjusting a parameter of the initial identification model based on the loss value.

In some embodiments, the receiving module 1501 is further configured to: receive reference service information transmitted by the terminal device, the reference service information being obtained by the terminal device from a third-party platform based on real-time location information of the target object.

The apparatus 150 further includes:
a storage module 1505, configured to:
perform compliance verification on the reference service information according to a preset information filtering policy; and
store the reference service information into the service information set as new original service information when the reference service information passes verification.

The apparatus may be configured to perform the method performed by the service server in the embodiments of this disclosure. Therefore, for functions and the like that can be implemented by the functional modules of the apparatus, refer to the descriptions in the foregoing embodiments, and details are not described herein again.

Refer to FIG. 16. Based on a same inventive concept, an embodiment of this disclosure further provides a service processing apparatus 160, applied to a terminal device. The apparatus includes:
a receiving module 1601, configured to receive at least one piece of candidate service information transmitted by a service server, the at least one piece of candidate service information being determined by the service server based on a biometric feature and location information of a target object;
a determining module 1602, configured to determine at least one piece of target service information from the at least one piece of candidate service information in response to a selection operation triggered by the target object; and
a transmission module 1603, configured to transmit the at least one piece of target service information to the service server, so that the service server processes a service corresponding to each piece of target service information in the at least one piece of target service information.

The apparatus may be configured to perform the method performed by the terminal device in the embodiments of this disclosure. Therefore, for functions and the like that can be implemented by the functional modules of the apparatus, refer to the descriptions in the foregoing embodiments, and details are not described herein again.

Refer to FIG. 17. Based on a same inventive concept, an embodiment of this disclosure further provides a service processing apparatus 170, applied to a biometric recognition apparatus. The apparatus includes:
an obtaining module 1701, configured to obtain object description information of a target object, the object description information including a biometric feature and location information of the target object; and
a transmission module 1702, configured to transmit the object description information to a service server, so that the service server performs the following operations: obtaining at least one piece of candidate service information based on the biometric feature and the location information, transmitting the at least one piece of candidate service information to a terminal device, and performing service processing based on at least one piece of target service information returned by the terminal device, each piece of target service information being determined by the terminal device from the at least one piece of candidate service information in response to a selection operation triggered by the target object.

The apparatus may be configured to perform the method performed by the biometric recognition apparatus in the embodiments of this disclosure. Therefore, for functions and the like that can be implemented by the functional modules of the apparatus, refer to the descriptions in the foregoing embodiments, and details are not described herein again.

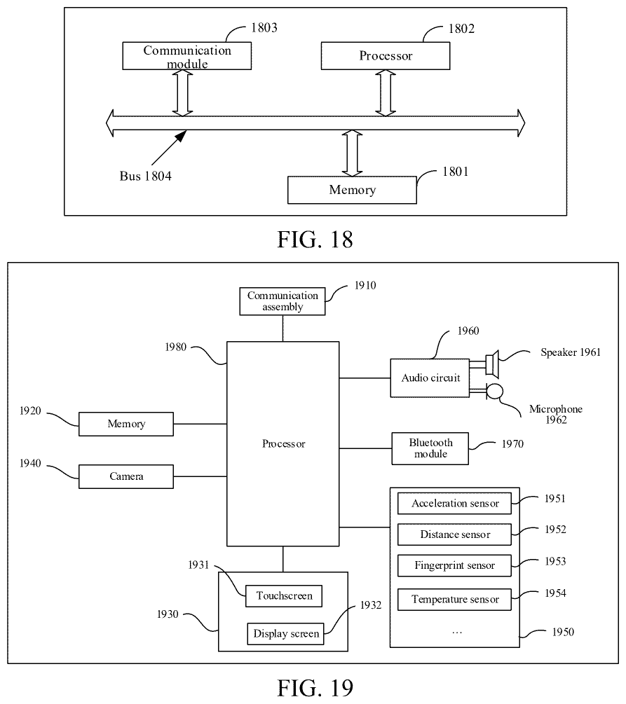

Refer to FIG. 18. Based on a same inventive concept, an embodiment of this disclosure further provides a computer device. In an embodiment, the computer device may be the service server shown in FIG. 1. As shown in FIG. 18, the computer device includes a memory 1801, a communication module 1803, and at least one processor 1802.

The memory 1801 is configured to store a computer program executed by the processor 1802. The memory 1801 may mainly include a program storage region and a data storage region. The program storage region may store an operating system, a program required for running an instant messaging function, and the like. The data storage region may store various instant messaging information, an operation instruction set, and the like.

The memory 1801 may be a volatile memory, for example, a random-access memory (RAM). Alternatively, the memory 1801 may be a non-volatile memory, for example, a read-only memory, a flash memory, a hard disk drive (HDD) or a solid-state drive (SSD). Alternatively, the memory 1801 is any other medium that can be used to carry or store expected program code in a form of an instruction or a data structure and that can be accessed by a computer, but is not limited thereto. The memory 1801 may be a combination of the foregoing memories.

The processor 1802 may include one or more central processing units (CPUs), a digital processing unit, or the like. The processor 1802 is configured to implement the foregoing biometric recognition-based service processing method when invoking the computer program stored in the memory 1801.

The communication module 1803 is configured to communicate with a terminal device, a biometric recognition apparatus, or another server.

A specific connecting medium between the memory 1801, the communication module 1803, and the processor 1802 is not limited in this embodiment of this disclosure. In this embodiment of this disclosure, the memory 1801 and the processor 1802 are connected through a bus 1804 in FIG. 18. The bus 1804 is described by a thick line in FIG. 18, and connections between other components are merely examples for description, and shall not be construed as a limitation. The bus 1804 may be classified as an address bus, a data bus, a control bus, and the like. For ease of description, only one thick line is for describing the bus in FIG. 18, but this does not mean that there is only one bus or only one type of bus.

The memory 1801 has a computer storage medium stored therein, the computer storage medium has computer-executable instructions stored therein, and the computer-executable instructions are configured for implementing the biometric recognition-based service processing method in the embodiments of this disclosure. The processor 1802 is configured to perform the biometric recognition-based service processing method.

In another embodiment, the computer device may be the terminal device or the biometric recognition apparatus shown in FIG. 1. In this embodiment, a structure of the computer device may be shown in FIG. 19, including: components such as a communication assembly 1910, a memory 1920, a display unit 1930, a camera 1940, a sensor 1950, an audio circuit 1960, a Bluetooth module 1970, and a processor 1980.

The communication assembly 1910 is configured to communicate with a service server. In some embodiments, a circuit wireless fidelity (Wi-Fi) module may be included. The Wi-Fi module is a short distance wireless transmission technology, and the computer device can help a user transmit and receive information via the Wi-Fi module.

The memory 1920 may be configured to store a software program and data. The processor 1980 executes various functions and data processing of the terminal device by running the software program or data stored in the memory 1920. The memory 1920 may include a high-speed random-access memory, or may include a non-volatile memory, such as at least one magnetic disk storage device, a flash memory device, or another volatile solid-state storage device. The memory 1920 has an operating system stored therein that enables the terminal device to run. In this disclosure, the memory 1920 may store the operating system and various applications, and may further store code for performing the biometric recognition-based service processing method in the embodiments of this disclosure.

The display unit 1930 may be further configured to display information entered by a user or information provided for a user, and a graphical user interface (GUI) of various menus of the terminal device. In some aspects, the display unit 1930 may include a display screen 1932 disposed on a front of the terminal device or the biometric recognition apparatus. The display screen 1932 may be configured in a form of a liquid crystal display, an organic light-emitting diode, and the like. The display unit 1930 may be configured to display at least one piece of candidate service information in the embodiments of this disclosure, respond to a selection operation of a target object, or the like.

The display unit 1930 may be further configured to receive inputted digit or character information, and generate a signal input related to a user setting and function control of the terminal device. In some aspects, the display unit 1930 may include a touchscreen 1931 disposed on the front of the terminal device, which may collect touch operations of the user on or near the touchscreen, for example, tapping a button and dragging a scroll box.

The touchscreen 1931 may cover the display screen 1932, or the touchscreen 1931 and the display screen 1932 may be integrated to implement an input function and an output function of the terminal device, which may be referred to as a touch display screen after integration. In this disclosure, the display unit 1930 may display the application and corresponding operating operations.

The camera 1940 may be configured to capture a static image, and the user may issue the image captured by the camera 1940 through the application. There may be one or more cameras 1940. An optical image of an object is generated through a lens, and is projected to a photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transfers the electrical signal to the processor 1980 for conversion into a digital image signal.

The terminal device may further include at least one sensor 1950, for example, an acceleration sensor 1951, a distance sensor 1952, a fingerprint sensor 1953, and a temperature sensor 1954. The terminal device may be further configured with other sensors such as a gyroscope, a barometer, a hygrometer, a thermometer, an infrared sensor, an optical sensor, and a motion sensor.

The audio circuit 1960, a speaker 1961, and a microphone 1962 may provide an audio interface between the user and the terminal device. The audio circuit 1960 may convert received audio data into an electrical signal, and transmit the electrical signal to the speaker 1961. The speaker 1961 converts the electrical signal into a sound signal, and outputs the sound signal. The terminal device may be further configured with a volume button, configured to adjust a volume of the sound signal. In addition, the microphone 1962 converts a collected sound signal into an electrical signal, and the audio circuit 1960 receives the electrical signal, converts the electrical signal into audio data, and then outputs the audio data to the communication assembly 1910 for transmission to, for example, another terminal device, or outputs the audio data to the memory 1920 for further processing.

The Bluetooth module 1970 is configured to perform information exchange with another Bluetooth device having a Bluetooth module by using a Bluetooth protocol. For example, the terminal device may establish, by using the Bluetooth module 1970, a Bluetooth connection to a wearable computer device (for example, a smartwatch) that also has a Bluetooth module, to perform data exchange.

The processor 1980 is a control center of the terminal device that connects various parts of the entire terminal by using various interfaces and lines. The processor 1980 performs various functions of the terminal device and processes data by running or executing the software program stored in the memory 1920 and invoking the data stored in the memory 1920. In some embodiments, the processor 1980 may include at least one processing unit. The processor 1980 may alternatively integrate an application processor and a baseband processor. The application processor mainly processes the operating system, a user interface, the application, and the like, and the baseband processor mainly processes wireless communication. Alternatively, the baseband processor may not be integrated into the processor 1980. In this disclosure, the processor 1980 may run the operating system, the application, user interface display, and a touch response, and perform the biometric recognition-based service processing method in the embodiments of this disclosure. In addition, the processor 1980 is coupled to the display unit 1930.

Based on a same inventive concept, an embodiment of this disclosure further provides a storage medium. A computer program is stored in the storage medium. The computer program, when run on a computer, causes the computer to perform the operations of the biometric recognition-based service processing method according to the exemplary implementations of this disclosure described above in the specification.

In some examples of implementations, aspects of the service processing method provided in this disclosure may be further implemented in a form of a computer program product, which includes a computer program. When the program product is run on a computer device, the computer program is configured to cause the computer device to perform the operations of the biometric recognition-based service processing method according to the exemplary implementations of this disclosure described above in the specification, for example, the computer device may perform the operations in the embodiments.

The program product may use any combination of at least one readable medium. The readable medium may be a readable signal medium or a readable storage medium. The readable storage medium may be, for example, but is not limited to, an electric, magnetic, optical, electromagnetic, infrared, or semi-conductive system, apparatus, or device, or any combination thereof. More specific examples (nonexhaustive list) of the readable storage medium include: an electrical connection having at least one wire, a portable disk, a hard disk drive, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof.

The program product according to the implementation of this disclosure may use a portable compact disc read-only memory (CD-ROM), includes a computer program, and may be run on the computer device. However, the program product in this disclosure is not limited thereto. In this document, the readable storage medium may be any tangible medium including or storing a program, and the computer program included in the readable storage medium may be used by or in combination with a command execution system, apparatus, or device.

The readable signal medium may include a data signal propagated in a baseband or as a part of a carrier, in which the readable computer program is carried. A data signal propagated in such a way may be in a plurality of forms, including, but not limited to, an electromagnetic signal, an optical signal, or any suitable combination thereof. The readable signal medium may alternatively be any readable medium other than the readable storage medium, and the readable medium may send, propagate, or transmit a program used by or in combination with an instruction execution system, apparatus, or device.

The computer program included in the readable medium may be transmitted by using any suitable medium, including, but not limited to, a wireless medium, a wired medium, an optical cable, an RF, or the like, or any suitable combination thereof.

The computer program configured to perform the operations in this disclosure may be compiled by using one or more programming languages or any combination thereof. The programming languages include object-oriented programming languages such as Java and C++, and further include related procedural programming languages such as a “C” language or similar programming languages.

Although several units or subunits of the apparatus are mentioned in the foregoing detailed descriptions, such division is merely exemplary and not mandatory. In fact, according to the implementations of this disclosure, features and functions of two or more units described above may be specified in one unit. On the contrary, the features or functions of one unit described above may be further divided and specified by a plurality of units.

In addition, although the operations of the method in this disclosure are described in a specific order in the accompanying drawings, this does not require or imply that the operations are bound to be executed in the specific order, or all the operations shown are bound to be executed to achieve the expected result. Additionally or alternatively, some operations may be omitted, a plurality of operations may be combined into one operation for execution, and/or one operation may be decomposed into a plurality of operations for execution.

It is noted that the embodiments of this disclosure may be provided as a method, a system, or a computer program product. Therefore, this disclosure may use a form of hardware-only embodiments, software-only embodiments, or embodiments combining software and hardware. Moreover, this disclosure may use a form of a computer program product that is implemented on at least one computer-usable storage medium (including, but not limited to, a disk memory, a CD-ROM, an optical memory, and the like) that includes computer-usable program code.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of service processing, the method comprising:
receiving object description information that is transmitted by a biometric recognition apparatus, the object description information comprising a biometric feature of a target object and location information of the target object;
obtaining identity information of the target object according to the biometric feature;
obtaining a service information set in association with the identity information;
selecting, from the service information set, one or more pieces of candidate service information based on location information associated with the one or more pieces of candidate service information and the location information of the target object;
transmitting the one or more pieces of candidate service information to a terminal device associated with the identity information;
receiving at least a first piece of target service information returned by the terminal device, the first piece of target service information being selected from the one or more pieces of candidate service information; and
processing at least a first service corresponding to the first piece of target service information.

2. The method according to claim 1, wherein:
the service information set comprises a plurality of pieces of original service information, and
the selecting comprises:
obtaining a target scenario type according to the location information of the target object;
obtaining respective scenario matching degrees of the plurality of pieces of original service information to the target scenario type; and
determining a piece of original service information with a scenario matching degree satisfying a preset matching condition as one of the one or more pieces of candidate service information.

3. The method according to claim 1, wherein the obtaining the identity information comprises:
performing an identification based on the biometric feature to obtain an identity identifier for the biometric feature; and
determining the identity information that is associated with the identity identifier.

4. The method according to claim 1, wherein the obtaining the identity information comprises:
matching the biometric feature to at least one prestored candidate feature to determine a successfully matched candidate feature from the at least one prestored candidate feature, the at least one prestored candidate feature being stored in association with respective identity information, the successfully matched candidate feature being associated with first identity information; and
using the first identity information associated with the successfully matched candidate feature as the identity information.

5. The method according to claim 3, wherein the performing the identification comprises:
providing the biometric feature as an input to a trained identification model to obtain the identity identifier that is output from the trained identification model.

6. The method according to claim 5, wherein:
a training process to obtain the trained identification model comprises:
obtaining sample data, the sample data comprising a plurality of sample identity identifiers and sample biometric features respectively corresponding to the plurality of sample identity identifiers; and
performing iterative training rounds with an initial identification model based on the sample data, to obtain the trained identification model, and
a current iterative training round in the iterative training rounds comprises:
predicting, by using an intermediate identification model that has been updated from the initial identification model based on previous iterative training rounds of the current iterative training round, a current sample biometric feature in the sample data for the current iterative training round, to obtain a predicted identity identifier of the current sample biometric feature;
determining a difference between a current sample identity identifier corresponding to the current sample biometric feature and the predicted identity identifier as a loss value; and
adjusting at least a parameter of the intermediate identification model based on the loss value.

7. The method according to claim 1, further comprising:
receiving at least a piece of reference service information that is transmitted by the terminal device, the piece of reference service information being obtained by the terminal device from a third-party platform based on the location information of the target object in real-time;
performing compliance verification on the piece of reference service information according to a preset information filtering policy; and
storing the piece of reference service information into the service information set as a new piece of original service information when the piece of reference service information passes verification.

8. The method according to claim 1, wherein the biometric feature of the target object comprises at least one of:
a feature extracted from a palm image of the target object;
a feature extracted from a face image of the target object;
a feature extracted from a palm vein image of the target object;
a feature extracted from an iris image of the target object; and/or
a feature extracted from voice of the target object.

9. The method according to claim 1, wherein the location information of the target object comprises location information of the biometric recognition apparatus.

10. The method according to claim 1, wherein the location information of the target object is updated based on real-time location information provided by the terminal device.

11. The method according to claim 1, wherein the location information of the target object is updated based on real-time location information of a vehicle.

12. The method according to claim 2, wherein the obtaining the respective scenario matching degrees comprises:
calculating a semantic matching degree of text information of a piece of original service information in the plurality of pieces of original service information and the target scenario type as a scenario matching degree of the piece of original service information.

13. The method according to claim 2, wherein the obtaining the respective scenario matching degrees comprises:
calculating a geographic distance between service location information of a piece of original service information in the plurality of pieces of original service information and the location information of the target object as a scenario matching degree of the piece of original service information.

14. The method according to claim 2, wherein the obtaining the respective scenario matching degrees comprises:
calculating a matching degree between preset scenario type information of a piece of original service information in the plurality of pieces of original service information and the target scenario type as a scenario matching degree of the piece of original service information.

15. The method according to claim 2, wherein the obtaining the respective scenario matching degrees comprises:
obtaining a scenario matching degree of the piece of original service information and the target scenario type according to a trained model.

16. A method of service processing, the method comprising:
receiving one or more pieces of candidate service information that are transmitted by a service server, the one or more pieces of candidate service information being determined by the service server based on a biometric feature of a target object and location information of the target object;
determining at least a piece of target service information from the one or more pieces of candidate service information in response to a selection operation triggered by the target object; and
transmitting at least the piece of target service information to the service server to cause the service server to process at least a service corresponding to the piece of target service information.

17. The method according to claim 16, further comprising:
obtaining real-time location information of the target object;
matching the real-time location information to a plurality of pieces of preset location information to obtain a matching piece of preset location information when the matching succeeds;
obtaining, based on a preset scenario type of the matching piece of preset location information, reference service information from a third-party platform associated with the preset scenario type; and
transmitting the reference service information to the service server to cause the service server to store the reference service information into a service information set as a new piece of original service information, the service information set comprising a plurality of pieces of original service information.

18. A method of service processing, the method comprising:
obtaining object description information of a target object, the object description information comprising a biometric feature of the target object and location information of the target object; and
transmitting the object description information to a service server to cause the service server to perform:
obtaining one or more pieces of candidate service information based on the biometric feature and the location information,
transmitting the one or more pieces of candidate service information to a terminal device, and
performing a service processing based on at least a piece of target service information that is selected from the one or more pieces of candidate service information by the terminal device.

19. The method according to claim 18, wherein the obtaining the object description information comprises:
obtaining a biometric image of the target object in response to a biometric recognition operation triggered by the target object;
extracting the biometric feature from the biometric image; and
obtaining the object description information based on the location information of the target object and the biometric feature.

20. The method according to claim 19, wherein:
the biometric recognition operation comprises a palm scanning recognition operation;
the obtaining the biometric image comprises:
acquiring a palm image set of the target object in response to the palm scanning recognition operation, the palm image set comprising a palm print image and a palm vein image; and
the extracting the biometric feature comprises:
performing a liveness detection on the target object based on the palm vein image;
extracting a palm print feature from the palm print image and a palm vein feature from the palm vein image when the target object passes the liveness detection; and
merging the palm print feature and the palm vein feature to obtain the biometric feature.
